(19) United States
(12) Patent Application Publication
(10) Pub. No.: US 2005/0165640 A1
(43) Pub. Date: Jul. 28, 2005

(54) Peer-to-peer marketing business method for telecommunication devices with digital displays

(76) Inventor: Radoslav P. Kotorov, Somerset, NJ (US)

Correspondence Address: RADOSIAV P. KOTOROV, 7 JULIP CT., SOMERSET, NJ, 08873, US

(21) Appl. No.: 10/905,518

(22) Filed: Jan. 7, 2005

Related U.S. Application Data
(60) Provisional application No. 60/537,718, filed on Jan. 22, 2004.

(51) Int. Cl. G06F 17/60

(52) U.S. Cl. 705/14

(57) ABSTRACT

A method and system for administering a peer-to-peer marketing program for telecommunication devices with digital displays. The peer-to-peer method allows telecommunication consumers to enroll their phone numbers in the program to distribute marketing content on calls, text and picture messages, and earn rewards for each impression displayed on recipients' devices. The advertising and marketing materials are displayed on the recipients' devices as images on the display, as backgrounds to caller IDs, as sidelines to picture messages, as headers/footers to a text messages, etc. The rewards and other conditions for the peer-to-peer distribution of advertising materials are defined by the advertising sponsors. Rewards are allocated based on the quantity and rate for each delivered impression.

This application is a continuation of our provisional patent application No. 60/537,718, filed on Jan. 22, 2004, now abandoned.

### FIELD OF THE INVENTION

The present invention relates to transaction processing, analysis systems, marketing application systems, and marketing loyalty programs. In particular, it relates to the use of those systems to facilitate marketing material distribution in a peer-to-peer telecommunications network.

### BACKGROUND OF THE INVENTION

The telephone has been recognized and used as a valuable and effective marketing tool for a long time. Direct marketing, i.e., the method of calling individuals selected from acquired lists of phone numbers to present to them consumer offers, has grown into an entire industry with hundreds of call centers employing many telemarketers.

The rapid growth of mobile, internet and video telecommunications has opened new marketing frontiers. The new opportunities are driven by expanding technological capabilities of the phone sets and by the emergence of new services, such as picture and text messaging. High resolution color displays allow for the display of text and images, while robust user functionality makes it possible to interact and respond to multimedia content directly using the phone. The robust content display capabilities and the exponential growth in mobile telecommunications users, who carry their devices to be accessible all the time and anywhere, make the telecommunication network an even more valued marketing channel with higher reach than e-mail or television. Despite the obvious potential, no viable method for distribution of advertising materials to mobile, internet and video phones has emerged yet.

The direct to consumer marketing method that companies are trying to adapt for mobile, internet and video phones has significant disadvantages. Even prior to the emergence of mobile telecommunications and the ability to send advertising text or picture messages, the method of direct marketing has drawn significant criticism for being intrusive and invasive. Consumers have become increasingly irritated with the growing frequency of unsolicited advertising calls and also with their inconsiderate timing. The lack of means to filter out such calls prior to answering them, further justifies the criticism that marketers have monopolized the home/personal phone.

Deploying the direct to consumer marketing method to mobile, internet and video phones will only intensify the problem. For example, some advertisers have begun bursting marketing text messages to consumer cell phones. This method is analogous to the unsolicited email blasts that have become known as spam. Advertisers expect higher view rates on mobile phones compared to email, since consumers have fewer means to filter out advertising messages on cell phones as compared to their email inboxes. Furthermore, sophisticated bursting technologies allow to identify the location of mobile telecommunications users and to send localized marketing materials based on their proximity to retail locations. These technologies increase the targeting options, and, consequently, the frequency of unsolicited marketing messages received by telecommunication consumers.

The direct to consumer method faces huge challenges because it makes the consumer more vulnerable to unsolicited marketing materials, especially because the system can recognize both the user presence (online/offline; wireless network on/off) and the user location. As consumers view the cell phone as a very private device that makes them accessible at any time and place but mostly to a select group of people, they cannot be expected to tolerate intrusive direct marketing messaging. As more consumers abandon their landlines and switch entirely to mobile phones, the opportunities for direct marketing begin to diminish.

The challenge in making telecommunications and mobile marketing work is to be able to distribute marketing content unobtrusively, as is done using the peer-to-peer marketing method.

### SUMMARY OF THE INVENTION

In one embodiment the present invention solves the problems of the prior art by providing a method and a system for effective and efficient distribution of marketing content to telecommunication devices with digital displays. The peer-to-peer marketing method displays unobtrusively marketing content during consumer to consumer calls, text and picture messaging. Participating consumers select advertising materials and display them as backgrounds to their caller IDs, as sidelines to their picture messages, or as headers/footers to their text messages on the recipients' devices. For example, a consumer may select an advertisement image to be displayed behind or adjacent to his caller ID that appears on the recipient's phone when it rings to notify of the incoming call. An advertisement sponsor's name or some other sponsored text can be attached as header or footer to a personal text message sent to one or more recipients. Consumers can select advertising templates for their personal picture messaging. One template displays the advertising image prior to the personal picture; another displays the sponsor logo adjacent to the personal picture. The peer-to-peer marketing platform provides wide range of options and templates for displaying advertising content on recipients' phone sets. For each delivered impression, the participating consumers earn rewards from the advertisement sponsors who place the marketing content for peer-to-peer distribution.

The peer-to-peer method is an alternative solution to the direct to consumer telemarketing method and is expected to reduce the frequency of unsolicited calls and spam text messages. However, the overall circulation of marketing materials in the telecommunications network is expected to increase due to the scale-free nature of peer-to-peer networks and to the incentives provided to individuals for participation in the program. As people placed advertising materials on their personal websites to offset maintenance costs, so people are likely to distribute marketing messages to offset telecommunication costs, as long as these materials are embedded unobtrusively within the context of their personal calls, text and picture messages.

Further, the peer-to-peer marketing method provides for a more effective consumer targeting process. It is a well known maxim in consumer marketing that birds of the same feather flock together, i.e., it is more effective if marketers identify and target consumers with similar preferences. The peer-to-peer marketing method provides for a natural self selection process for distributing marketing messages to individuals with similar preferences. When consumers are given the choice to select advertising materials, they choose items and content that appeal to their own taste. Also a large percentage of their personal contacts are likely to have somewhat similar preferences. Hence, the advertisement selection process and their distribution within the consumer's network of personal contacts maximize the penetration of advertising materials among individuals with similar preferences. Furthermore, as the message comes from a peer, a “word-of-mouth” effect is created that increases the persuasiveness and the effectiveness of the campaign. Targeting can further be improved, if advertisement sponsors use the system to profile and segment the participants in the peer-to-peer program. Segments can be formed by analyzing self reported personal and psychographic data, acquired demographic data, behavioral data extrapolated from the transactional data captured in the system, and also other sources. Once the segmentation process is completed, advertising sponsors can limit the offer only to participants within desired segments.

Further, the present invention encourages higher participation in the peer-to-peer program because it rewards the consumers for embedding marketing content in their calls, text and picture messages. The nearly effortless distribution of marketing content on calls, text and picture messages and their unobtrusive presence, increase the incentive for individuals to participate and earn rewards. Further more, the peer-to-peer method provides for viral marketing and acquisition of new participants in the program. All content sent to non participants are stored in temporary accounts. Non participants are encouraged to visit the site, log on with their phone numbers and retrieve all advertising materials received. Upon completing the full registration process, they will be able to review sender information, advertisement terms and conditions, and also earn rewards if they choose to distribute some advertising materials.

In some embodiment of the present invention consumers can authorize other individuals or organizations, e.g., marketing agencies, telecom providers, businesses, etc., to select and manage the distribution of advertising materials on their behalf. In this case, the authorized third party selects the advertisements and their display specifications. The delegation method allows advertising aggregators to emerge and act on behalf of the consumers to find better deals and to make it more effortless for them to participate in the program. The consumer receives the benefits of participating without having to manage the advertisement selection process.

Further, the peer-to-peer marketing method allows for complete accountability of all served impressions and recipients' responses to the different calls to action. The transactional system captures information on all phone-to-phone calls, text messages and picture messages to which consumers have attached advertising content, and provides accurate information on the frequency and timing of each impression. Such detailed information cannot be captured by loyalty and frequent shopping marketing programs known from the prior art, for none of them provide full integration of impressions and behavioral data as the current system does.

With these and other objects, advantages, and features of the invention that may become hereafter apparent, the nature of the invention may be more clearly understood by reference to the following detailed description of the invention, the appended claims, and to the several drawings herein.

### DRAWING DESCRIPTION: BRIEF DESCRIPTION OF THE DRAWINGS

FIG. 1 is a representation of the various administrative and end user equipment that may be used to carry out the present invention.

FIG. 2 is a flow chart of the operation of the peer-to-peer marketing process in one embodiment of the present invention.

FIG. 3 is a drawing showing the user transmitting an advertisement image to the recipient's phone.

FIG. 4 is a flow chart of the processing and transmission system of the peer-to-peer marketing distribution method in one embodiment of the invention.

FIG. 5 is a flow chart of the user process and operation of the peer-to-peer marketing method.

FIG. 6 is a flow chart of the advertising sponsor process and operation of the peer-to-peer marketing method.

FIG. 7 (a) and 7(b) are representations of the user data processed by the peer-to-peer system.

FIG. 8(a) and 8(b) are representations of the database entries accessible by unregistered and registered users.

### DRAWING DESCRIPTION: DETAILED DESCRIPTION OF THE DRAWINGS

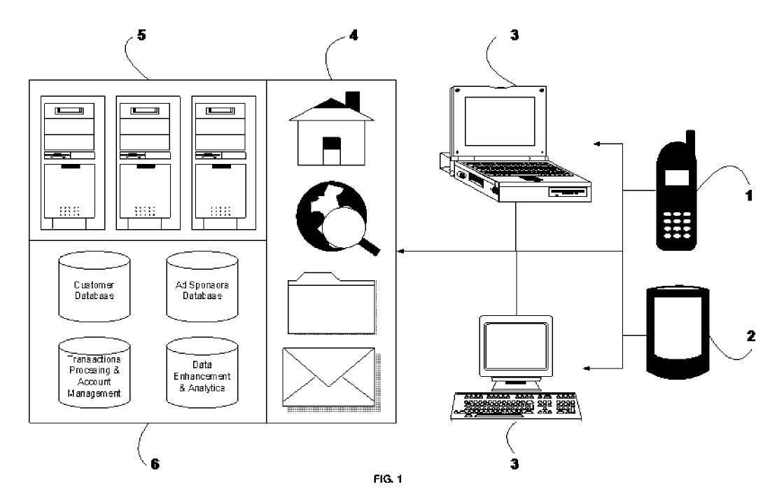

The equipment shown in FIG. 1, in one embodiment of the invention, is used to administer the peer-to-peer method and to manage user and advertisement sponsor accounts. Advertisement sponsors are individuals, businesses or other organizations willing to place marketing materials for peer-to-peer distribution to telecommunication devices with digital displays. Users are individuals or organizations who want to use their phone sets to distribute advertising materials during their calls, text or picture messages. Both users and advertisement sponsors can access and manage their accounts through a web browser 4 by using networked computers 3 or through their phones 1 and other mobile devices 2. All user and advertisement sponsor account information is stored in the system databases 6. The advertising materials are uploaded and stored in the system databases 6. An important feature of the invention is the development of a specialized database 6 to capture and store transactional information about the circulation of advertising materials in the peer-to-peer network and associate it with user and advertisement sponsor accounts. All user interactions and transactions are processed by the peer-to-peer marketing systems 5. Many other systems and database configurations are possible, as would be apparent to one skilled in the art, and the present invention is not meant to be limited to any particular type of logical database design and system architecture.

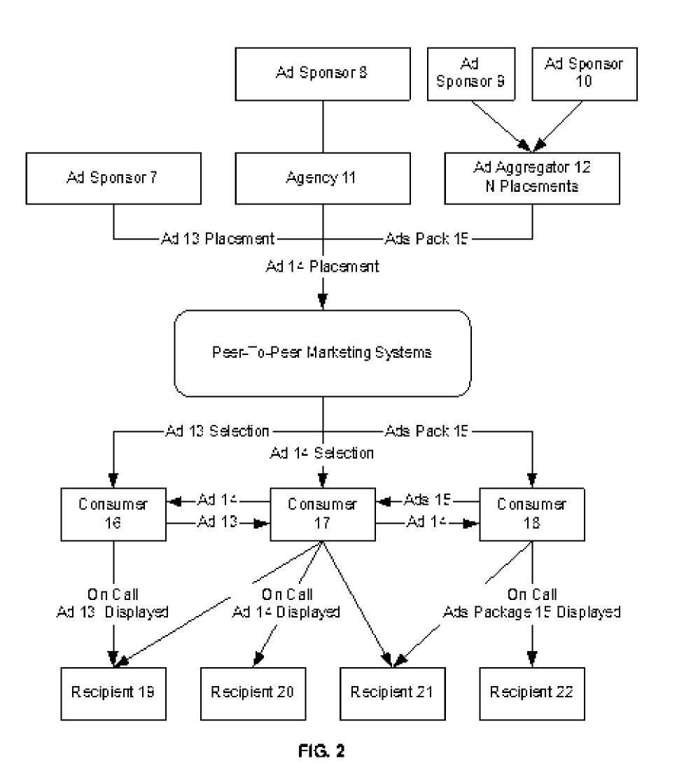

FIG. 2 is a flow chart of the operation of the peer-to-peer marketing process in one embodiment of the invention. Ad Sponsor 7 uploads the desired marketing materials to the peer-to-peer system. The materials may be uploaded directly in the required for transmission formats or can be converted by the system into the required for transmission formats. Ad Sponsor 8 may authorize an agency to manage its peer-to-peer marketing campaigns. Ad Sponsor 9 and Ad Sponsor 10 may use an Ad Aggregator 12 to manage their peer-to-peer campaigns. The agent placing the marketing content in the peer-to-peer marketing system defines the terms and conditions governing the advertisement distribution process.

An important feature of the invention is the ability of consumers to select different advertising materials and to associate them with the phone numbers enrolled in the program. More than one phone number can be enrolled in the user account. This feature is especially beneficial to businesses and organizations who want their employees and members to display logos on all outbound calls. Various search and sorting tools assist consumers in the advertisement selection process. As the flow chart shows, Consumer 16 has selected to display Ad 13 placed by Ad Sponsor 7; Consumer 17 has selected to display Ad 14 placed by the Agency 11 on behalf of Ad Sponsor 8; Consumer 18 has selected to display an Ads Package 15, containing a set of different advertisements, placed by Ad Aggregator 12 on behalf of Ad Sponsor 9 and Ad Sponsor 10. The Ad Package 15 is an important feature of the present invention for it allows a set of advertising materials to be displayed using some sequencing methods. There are numerous sequencing methods, such as random or simple rotations, that would be apparent to one skilled in the art, and the present invention is not meant to be limited to any particular sequencing method.

Another important feature of the present invention is the peer-to-peer circulation of the selected advertising materials. When Consumer 16 places a call, the selected Ad 13 is displayed on the recipient's device. Ad 13 can be displayed when the phone rings and displays the caller ID, when the phone is being answered, and/or through the duration of the call. There are many options when and how exactly to display the selected advertising material, which will become apparent to one skilled in the art, and the present invention is not meant to be limited to the display options listed in this specification. Consumer 16 can display advertisements on phone sets of non-members of the peer-to-peer marketing program, as is Recipient 19. Consumer 16 can also distribute advertisements when calling other members of the peer-to-peer program, e.g., when Consumer 16 calls Consumer 17, Ad 13 appears on the display of Consumer 17's phone.

An important effect of the invention is the dramatic increase in the penetration of advertising materials as they are distributed through the consumers' network of personal contacts. For example, Ad 14 is displayed on the phone sets of Recipients 19, 20 and 21, and also Consumer 18, who form Consumer 17's network of personal contacts.

FIG. 3 is a representation of the user experience. Consumer 23 calls another consumer. When the phone rings, the advertising image is displayed on the recipient's handset 24 as a background to the caller ID 25. When the recipient looks at the screen to inquire about the source of the call, identified by the caller ID 25, he is also exposed to the advertising material 26. The advertising material is not delivered in a separate call from unknown source as is in direct to consumer telemarketing, but instead is delivered unobtrusively behind the caller ID 25 of a trusted source.

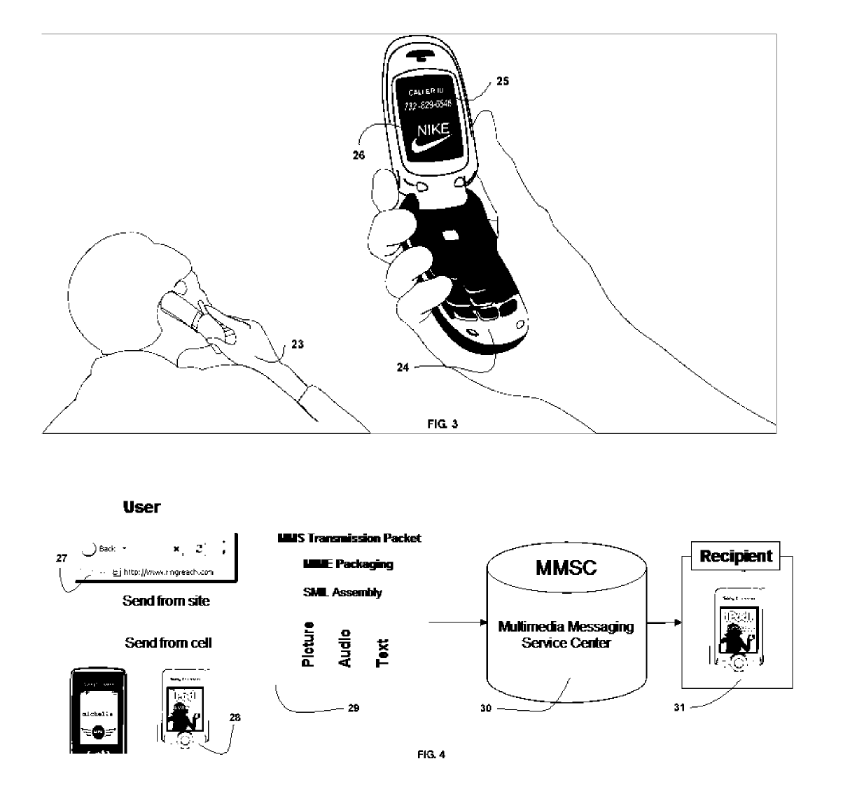

FIG. 4 is a flow chart of the processing and transmission system of the peer-to-peer marketing distribution method. Picture and text messages can be sent both from the system web site 27 or directly from a phone set 28. When a picture message is sent, it is assembled in a transmission packet 29 using MIME and SMIL protocols known from the prior art. The assembly of the message is not intended to be limited to those two protocols only. Text messages use the HTTP protocol known from the prior art. The packet 29 is sent to a Multimedia Messaging Service Center 30 which re-routes it to Recipient 31 and also captures all relevant transmission data. Capturing all attributes of the advertising materials embedded in the telecommunication sessions is an important feature of the present invention allowing for complete measurement of the circulation of impressions in the peer-to-peer network and for accurate allocation of rewards. The Multimedia Messaging Service Center 30, which is known from the prior art, may be operated by an independent company or a mobile operator contracted by the peer-to-peer marketing program.

FIG. 5 is a flow chart of the user process and operation of the peer-to-peer marketing method. The user creates a user account and enrolls in the account the phone numbers participating in the peer-to-peer marketing program. The user account can contain numerous personal data elements to facilitate the segmentation of participants. An important feature of the invention is the ability of users to associate specific advertising materials with the enrolled phone numbers and services, such as calls, text and picture messaging. For example, if the user has enrolled two phone numbers, she may select different advertising materials for each one of them. The user may also select one advertising material, but different advertisement sponsor templates for each phone set. Thus, a personal picture can be sent with the sponsor's name appearing at the bottom of the picture when it is sent from one phone set, and on the top of the picture when it is sent from the other phone set. Robust account management capabilities allow users to limit the distribution of advertisements according to specific rules, e.g., to be sent to specific groups of recipients, to be sent to specific area codes, to be send within a specific time period, etc. Numerous distribution configurations will become apparent to those skilled in the art, and it is not the intent of the present invention to limit the distribution algorithms to those defined in this specification. Data is captured on all calls, text and picture messages with embedded marketing messages.

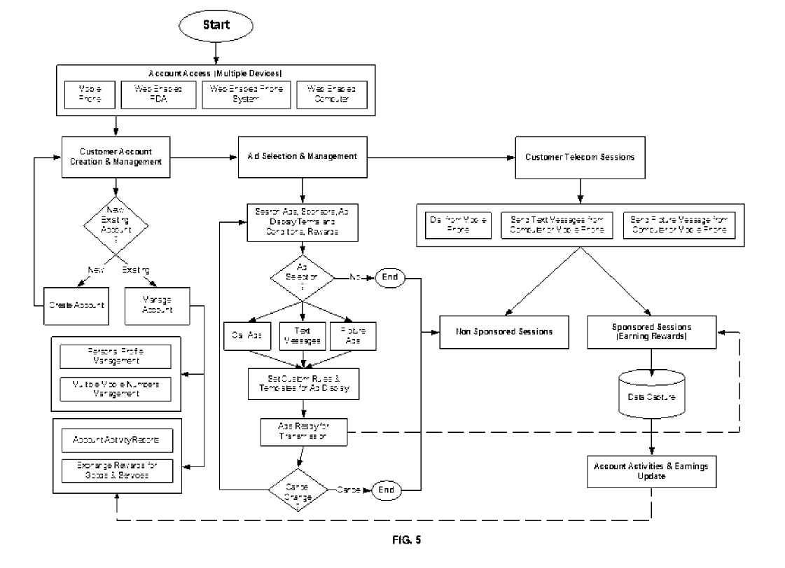

FIG. 6 is a flow chart of the advertising sponsor process and operation of the peer-to-peer marketing method. It shows how advertisement sponsors open and manage their accounts. An important feature of the invention is the ability of advertisement sponsors to define different templates for each type of service, e.g., calls, text and picture messages, and to establish the terms and conditions for peer-to-peer distribution, such as duration of campaigns, reward rules, targeting rules when the rewards offer is limited to specific participant segments, etc. Another important feature is the ability of account managers to set limits on the number of impressions served in order to control the overall cost in a scale-free network like the peer-to-peer telecommunications network. If such limits are set, the system discontinues the distribution and notifies the participants that the offer is no longer valid. The flow chart shows how the system captures all impressions and delivers real time performance and accounting data to the participating advertisement sponsors.

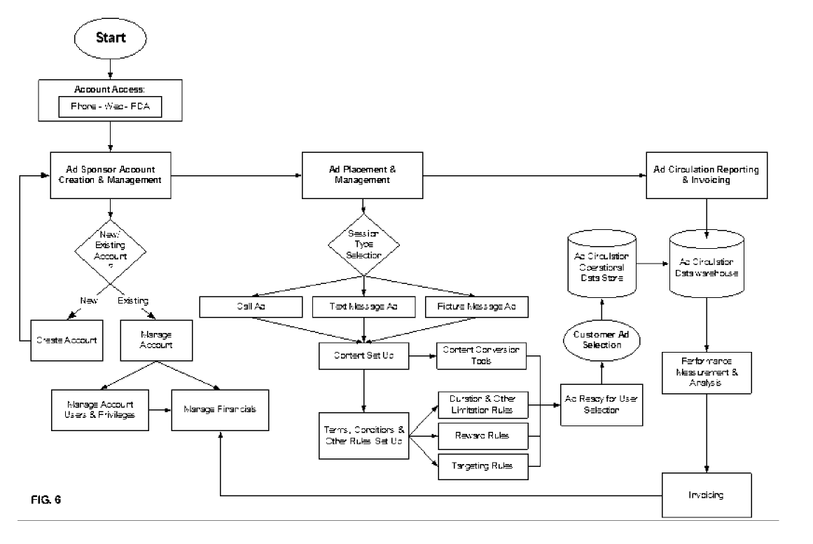

FIG. 7(a) is a representation of the user data records created for each impression served. The record contains the phone number on which the advertisement was displayed, the date and time of the communication session, the type of the communication session, i.e., a call, text or picture message, the inventory number of advertisement displayed. These records can be used to generate many different types of activity and rewards earning reports. The underscoring of records indicates that the user can drill down and display additional details on the record. As shown on FIG. 7(b), if the user drills down on the displayed advertisement inventory number, he/she can obtain information on the type of advertisement and its terms and conditions. Advertisements may have no call to action, a single call to action, or tiered calls to action. When the rewards are tiered, the distributor receives a base reward for the impression and increasing rewards for click-throughs and purchase orders. Drill down paths can be established for all data elements and at any desired level.

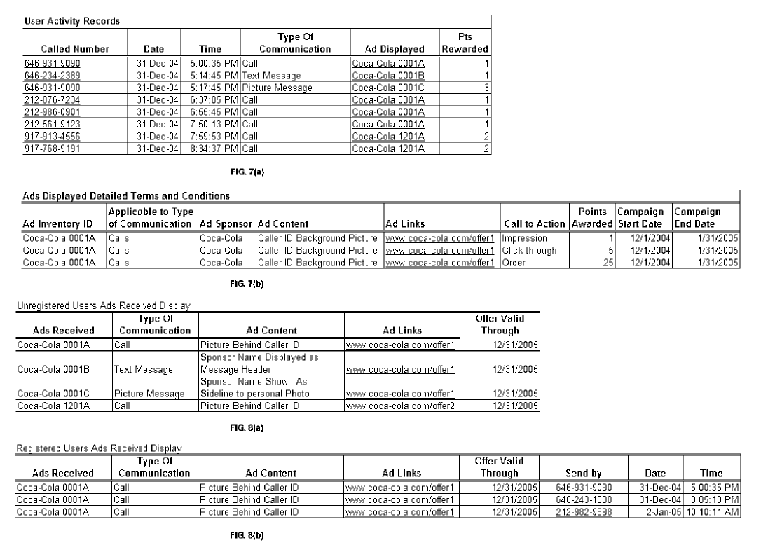

FIG. 8(a) show the information captured and displayed to unregistered users. Unregistered users are encouraged to come to the peer-to-peer marketing site and review the advertisements that they have received. They are identified by their phone number. Unregistered users can see only aggregate level information, i.e., types of advertisements received but not frequency, sender or advertisement sponsor details. FIG. 8(b) shows the additional information that is displayed to registered users, who can view details on each data element. Registered user phone numbers cannot be used without a password to retrieve even aggregate level information. The information display process is an important feature of the invention designed to protect the privacy of both senders and recipients of peer-to-peer marketing.

Although the present invention has been shown and described with respect to preferred embodiments, various changes and modifications that are obvious to a person skilled in the art to which this invention pertains, even if not shown or specifically described herein, are deemed to lie within the spirit and scope of the present invention. Any numbering of the elements of the following claims is merely for convenience and is not intended to suggest that the ordering of the elements of the claims has any particular significance other than that otherwise expressed by the language of the claims.

1) A method for peer-to-peer circulation of advertising and marketing materials embedded in personal calls, text or picture messages and displayed on recipients' telecommunication devices during incoming communications with the distributors, comprising:
(a) creating advertising and marketing materials placement accounts for peer-to-peer circulation;
(b) placing advertising and marketing materials for peer-to-peer circulation using the placement accounts;
(c) creating peer-to-peer distributor accounts;
(d) registering in the distributor account one or more telephone numbers to be used for disseminating advertising and marketing materials;
(e) associating advertising and marketing materials with the registered telephone numbers in the distributor account to be displayed on recipients' devices;
(f) transmitting the embedded advertising and marketing messages as part of the distributor's calls, text or picture messages;
(g) displaying the advertising and marketing messages on the recipients' devices during calls, text or picture messages;
(h) capturing information on the frequency, timing and other attributes of each impression displayed on the receivers' devices during peer-to-peer communications.

2) The method of claim 1, wherein the act (b) includes the acts of:
posting advertising and marketing materials for review and selection by peer-to-peer distributors;
specifying different display formats and templates for calls, text and picture messages;
setting individual formats and templates for particular posted advertising and marketing materials; and
specifying terms and conditions for the peer-to-peer distribution of the posted advertising and marketing materials.

3) The method of claim 1, wherein the act (e) includes the acts of:
selecting advertising and marketing materials to be distributed and displayed on recipients' devices;
assigning advertising and marketing materials to registered phone numbers for transmission and display during outbound communications;
managing the frequency, timing and other attributes for displaying advertising and marketing materials on recipients' devices.

4) The method of claim 1, wherein the act (g) includes the acts of:
displaying advertising and marketing materials within the digital display of the receiving device;
displaying advertising and marketing materials as backgrounds to caller Ids;
displaying advertising and marketing messages as headers or footers to text messages; and
displaying advertising messages as pre-screens, sidelines or end-screens of picture messages.

5) The method of claim 1, further comprising the act of:
(i) authorizing third parties to use the distributor account to manage the circulation of advertising and marketing materials.

6) The method of claim 1, further comprising the acts of:
(j) using specific devices with each number registered in the account for distribution of advertising and marketing materials; and
(k) loading in the device codes and templates for identification, transmission and display formatting of the selected for dissemination advertising and marketing materials.

7) The method of claim 1, further comprising the acts of:
(l) rewarding peer-to-peer distributors for the advertising impressions displayed on the recipients' devices; and
(m) exchanging accumulated rewards for goods and services.

8) The method of claim 7, wherein the act (l) includes the act of:
allocating rewards based on the frequency and rate of the displayed advertising and marketing materials.

9) The method of claim 1, further comprising the acts of:
(n) accessing all sent and received advertising and marketing materials by using directly a telecommunication device or from within an account; and
(o) responding to advertising and marketing materials by using directly a telecommunication device or from within an account.

10) A system for posting, transmitting and tracking peer-to-peer circulation of advertising and marketing materials, comprising:
(a) A processing system for posting, selection and transmission of advertising and marketing materials associated with peer-to-peer distribution accounts, wherein the materials are embedded and displayed on recipients' devices during incoming calls, text and picture messages;
(b) A transaction system that acquires and captures information about distributors' outbound calls, wherein the outbound calling information includes information about the advertising and marketing material displayed on the recipient's device;
(c) A network that connects to the transaction and processing systems;
(d) An integration system that links advertising and marketing materials circulation data with account information.

11) The system in claim 10, further comprising of:
(e) A processing system that identifies the displayed advertising material and allocates reward to the distributor's account, wherein the reward allocation is based on predefined rules.
